(19) United States
(12) Patent Application Publication
(10) Pub. No.: US 2024/0064184 A1
(43) Pub. Date: Feb. 22, 2024

(54) NON-TRANSITORY COMPUTER READABLE MEDIUM, INFORMATION PROCESSING SYSTEM, AND INFORMATION PROCESSING METHOD

(71) Applicant: FUJIFILM Business Innovation Corp., Tokyo (JP)

(72) Inventor: Kohshiro INOMATA, Kanagawa (JP)

(73) Assignee: FUJIFILM Business Innovation Corp., Tokyo (JP)

(21) Appl. No.: 18/176,560

(22) Filed: Mar. 1, 2023

(30) Foreign Application Priority Data
Aug. 17, 2022 (JP) 2022-130148

(51) Int. Cl. H04L 65/403; G06T 11/00; H04N 5/272; G06F 3/16

(52) U.S. Cl. CPC H04L 65/403; G06T 11/001; H04N 5/272; G06F 3/16

(57) ABSTRACT

A non-transitory computer readable medium stores a program causing a computer to execute a process for information processing for a room in which metadata is transmitted and received by multiple terminal apparatuses, and the process includes causing at least one of the multiple terminal apparatuses to present states of multiple participants in the room in accordance with a shared rule determined in advance, the states being deduced from responses of the multiple participants.

### CROSS-REFERENCE TO RELATED APPLICATIONS

This application is based on and claims priority under 35 USC 119 from Japanese Patent Application No. 2022-130148 filed Aug. 17, 2022.

### BACKGROUND

### (i) Technical Field

The present disclosure relates to a non-transitory computer readable medium, an information processing system, and an information processing method.

### (ii) Related Art

A technology for analyzing actions based on image recognition is available for a remote conference.

Japanese Unexamined Patent Application Publication No. 2012-054897 discloses a conference system that includes multiple first information processing apparatuses and a second information processing apparatus; the multiple first information processing apparatuses each include an imaging device or a sound pick-up device, a unit configured to acquire an image from the imaging device or a voice from the sound pick-up device, and a transmit/receive unit configured to transmit and receive an acquired image or voice; the second information processing apparatus is connected to the multiple first information processing apparatuses by using a communication medium and is configured to relay images or voices transmitted or received by the first information processing apparatuses; and a conference is held by using the conference system in which the multiple first information processing apparatuses display or provide the same images or voices to share information. The conference system includes a recognizing unit, a detecting unit, and a transmission control unit; the recognizing unit is configured to recognize an action of a person in a captured image acquired by a first information processing apparatus; the detecting unit is configured to detect whether an inappropriate action is performed based on the recognition result obtained by the recognizing unit; and the transmission control unit is configured to, in accordance with the detection result obtained by the detecting unit, determine whether to receive an image or a voice from the first information processing apparatus or whether to transmit the image or the voice to another first information processing apparatus, or control an increase or a decrease in the transmission rate or the image processing of a portion of the image.

### SUMMARY

In a remote conference, which has been used in recent years, multiple terminal apparatuses connected by using a network transmit and receive voices, images, or video images of participants.

Grasping the atmosphere of a remote conference becomes more difficult as more people participate in the remote conference.

Aspects of non-limiting embodiments of the present disclosure relate to providing a non-transitory computer readable medium, an information processing system, and an information processing method that enable the atmosphere of a remote conference to be more easily grasped than by grasping the atmosphere of a remote conference based on a voice, an image, or a video image of each participant.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a non-transitory computer readable medium storing a program causing a computer to execute a process for information processing for a room in which metadata is transmitted and received by a plurality of terminal apparatuses, the process including causing at least one of the plurality of terminal apparatuses to present states of a plurality of participants in the room in accordance with a shared rule determined in advance, the states being deduced from responses of the plurality of participants.

### BRIEF DESCRIPTION OF THE DRAWINGS

Exemplary embodiments of the present disclosure will be described in detail based on the following figures, wherein:

FIG. 1 is an illustration depicting a schematic configuration of a system including an information processing apparatus;

FIG. 2 is a block diagram depicting a hardware configuration of an information processing apparatus according to the first exemplary embodiment;

FIG. 3 is a block diagram depicting a hardware configuration of a terminal apparatus according to the first exemplary embodiment;

FIG. 4 is a flowchart depicting a presentation process of the information processing apparatus according to the first exemplary embodiment;

FIG. 5 is a flowchart depicting a process performed by the information processing apparatus to apply a shared rule according to the first exemplary embodiment;

FIG. 6 is an example depicting a remote-conference screen of a terminal apparatus according to the first exemplary embodiment;

FIG. 7 is an example depicting a remote-conference screen of a terminal apparatus according to the first exemplary embodiment;

FIG. 8 is a flowchart depicting a process performed by the information processing apparatus to apply a shared rule according to the first exemplary embodiment;

FIG. 9 is a flowchart depicting a process performed by the information processing apparatus to apply a shared rule according to the first exemplary embodiment;

FIG. 10 is a flowchart depicting a process performed by the information processing apparatus to apply a shared rule according to the first exemplary embodiment;

FIG. 11 is a flowchart depicting a presentation process of an information processing apparatus according to the second exemplary embodiment;

FIG. 12 is an example depicting a remote-conference screen of a terminal apparatus according to the second exemplary embodiment;

FIG. 13 is an example depicting a remote-conference screen of a terminal apparatus according to the second exemplary embodiment;

FIG. 14 is a flowchart depicting a presentation process of an information processing apparatus according to a modification; and

FIG. 15 is a flowchart depicting a presentation process of an information processing apparatus according to a modification.

### DETAILED DESCRIPTION

Hereinafter, exemplary embodiments of a technology according to the present disclosure will be described with reference to the drawings. In the drawings, the same or equivalent components and parts are denoted by the same reference signs. The dimensions and proportions in the drawings are exaggerated for the sake of description and are not necessarily drawn to scale.

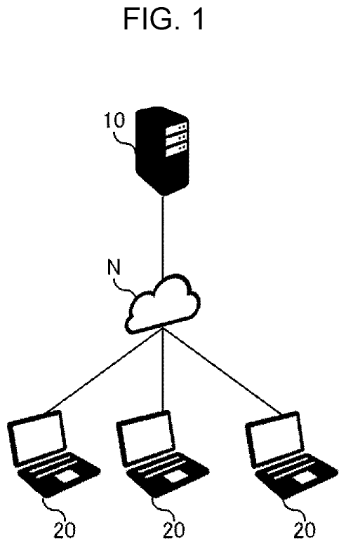

FIG. 1 is an illustration depicting a schematic configuration of a system including an information processing apparatus 10 according to an exemplary embodiment of the present disclosure. FIG. 1 illustrates that the information processing apparatus 10 is configured to provide a remote conference to multiple terminal apparatuses 20 by using a network N.

The information processing apparatus 10 is a server configured to provide a remote conference. The information processing apparatus 10 is configured to provide a remote conference service to the multiple terminal apparatuses 20 by transmitting and receiving images, video images, or voices. The information processing apparatus 10 is configured to share a document presented by a terminal apparatus 20 by causing another terminal apparatus 20 to display the same document.

Examples of a terminal apparatus 20 include a personal computer, a tablet terminal, or a smartphone, which is configured to participate in a remote conference. The terminal apparatus 20 is configured to participate in a remote conference room by transmitting and receiving images, video images, or voices as metadata to and from the information processing apparatus 10. For example, the terminal apparatus 20 is configured to transmit images or video images of one or more participants captured by a camera included in the terminal apparatus 20 to the information processing apparatus 10. For example, the terminal apparatus 20 is configured to transmit voices of one or more participants picked up by a microphone included in the terminal apparatus 20 to the information processing apparatus 10.

### First Exemplary Embodiment

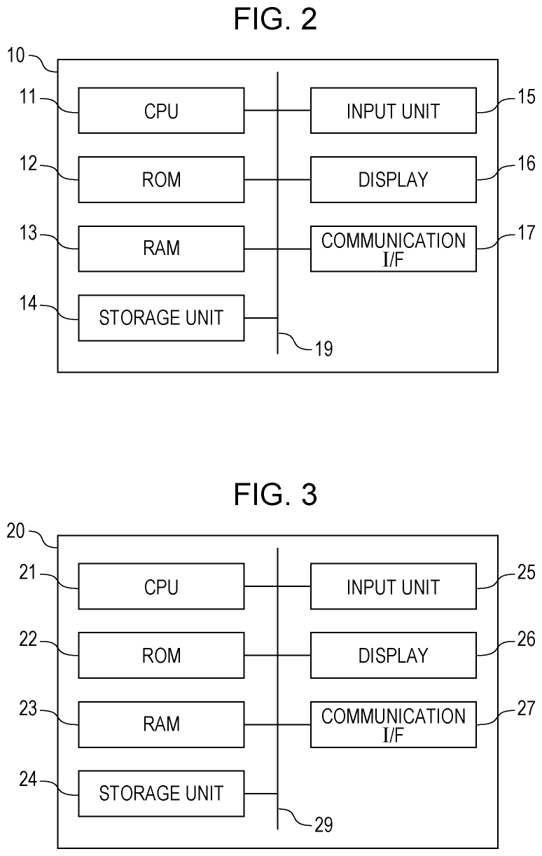

FIG. 2 is a block diagram depicting a hardware configuration of an information processing apparatus 10 according to the first exemplary embodiment. The information processing apparatus 10 includes a central processing unit (CPU) 11, a read-only memory (ROM) 12, a random-access memory (RAM) 13, a storage unit 14, an input unit 15, a display 16, and a communication interface (communication I/F) 17 as components. These components are communicatively connected to each other by using a bus 19.

The CPU 11, which is a central computing processing unit, is configured to execute various programs and control each component. Specifically, the CPU 11 loads programs from the ROM 12 or the storage unit 14 and uses the RAM 13 as a working space to execute the programs. The CPU 11 is configured to control each component described above and perform various kinds of computing processing in accordance with the programs recorded in the ROM 12 or in the storage unit 14. In the present exemplary embodiment, an information processing program for expressing a state is stored in the ROM 12 or in the storage unit 14.

The ROM 12 is configured to store various programs and various kinds of data. The RAM 13 is configured to function as a working space and temporarily retain a program or data. The storage unit 14 is formed by a hard disk drive (HDD) or a solid-state drive (SSD) and configured to store various programs including the operating system and various kinds of data.

The input unit 15 includes a pointing device, such as a mouse, and a keyboard and is used for receiving various kinds of input.

The display 16 is, for example, a liquid crystal display and is configured to present various kinds of information. The display 16 may include a touch panel system and may also function as the input unit 15.

The communication interface 17 is configured to communicate with another apparatus such as a database, and such a standard as Ethernet (registered trademark), FDDI, or Wi-Fi (registered trademark) is used.

FIG. 3 is a block diagram depicting a hardware configuration of a terminal apparatus 20 according to the first exemplary embodiment. The terminal apparatus 20 includes a CPU 21, a ROM 22, a RAM 23, a storage unit 24, an input unit 25, a display 26, and a communication interface (communication I/F) 27 as components. These components are communicatively connected to each other by using a bus 29.

The CPU 21, which is a central computing processing unit, is configured to execute various programs and control each component. Specifically, the CPU 21 loads programs from the ROM 22 or the storage unit 24 and uses the RAM 23 as a working space to execute the programs. The CPU 21 is configured to control each component described above and perform various kinds of computing processing in accordance with the programs recorded in the ROM 22 or in the storage unit 24. In the present exemplary embodiment, an information processing program for expressing a state is stored in the ROM 22 or in the storage unit 24.

The ROM 22 is configured to store various programs and various kinds of data. The RAM 23 is configured to function as a working space and temporarily retain a program or data. The storage unit 24 is formed by an HDD or an SSD and configured to store various programs including the operating system and various kinds of data.

The input unit 25 includes a pointing device, such as a mouse, and a keyboard and is used for receiving various kinds of input. The input unit 25 also includes a camera for capturing an image of a participant and a microphone for picking up a voice of a participant.

The display 26 is, for example, a liquid crystal display and is configured to present various kinds of information. The display 26 may include a touch panel system and may also function as the input unit 25.

The communication interface 27 is configured to communicate with another apparatus such as a database, and such a standard as Ethernet (registered trademark), FDDI, or Wi-Fi (registered trademark) is used.

Next, an operation of the information processing apparatus 10 according to the first exemplary embodiment will be described.

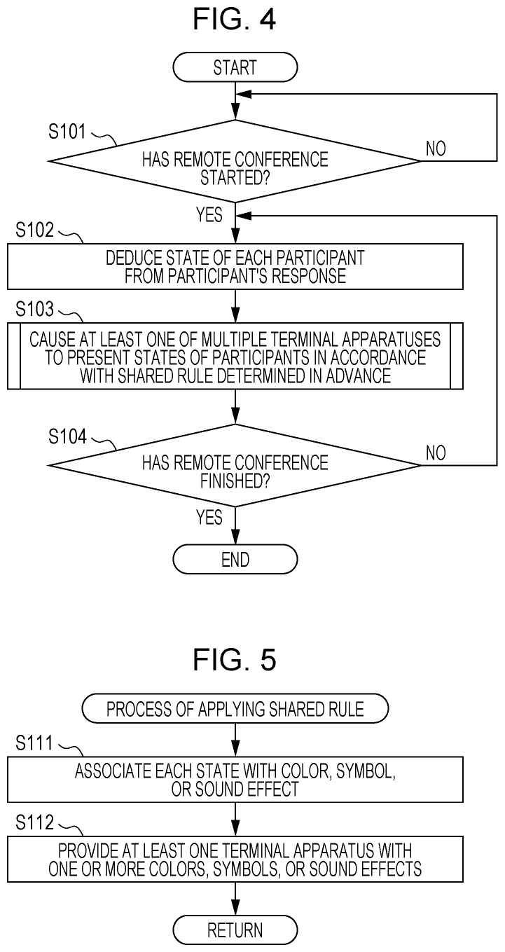

FIG. 4 is a flowchart depicting a presentation process performed by the information processing apparatus 10. The CPU 11 reads an information processing program stored in the ROM 12 or in the storage unit 14 and loads the information processing program onto the RAM 13 to execute the program, and then the presentation process is performed.

The CPU 11 determines in step S101 whether a remote conference has started. If the CPU 11 determines that a remote conference has started (YES in step S101), the CPU 11 proceeds to step S102. If the CPU 11 determines that a remote conference has not started (NO in step S101), the CPU 11 waits for a remote conference to start.

The CPU 11 deduces the state of each participant from the participant's response in step S102. The CPU 11 deduces the state of the participant, for example, from a captured image or video image of the participant, a voice or an action of the participant, the facial expression expressing the participant's emotion, the wording of a chat entered by the participant, or the function used by the participant for an action. The CPU 11 deduces the state of the participant, for example, by using facial expression recognition or person recognition, which is known technology, or machine learning. The CPU 11 may receive the deduced state of the participant from a terminal apparatus 20. Specifically, the CPU 21 of the terminal apparatus 20 deduces the state of the participant from an image or a video image of the participant captured by a camera, which is the input unit 25, and transmits the deduced state to the information processing apparatus 10. At this time, the CPU 21 of the terminal apparatus 20 may transmit the deduced state to the information processing apparatus 10 only when the state of the participant has changed. The CPU 11 proceeds to step S103.

Examples of the state include whether the participant is present or absent in front of the terminal apparatus 20, whether the participant is napping or awake, the participant's posture, facial expression, and emotion, whether the participant expresses a positive or negative attitude, and whether the participant has a question.

The CPU 11 causes at least one of the multiple terminal apparatuses 20 to present the states of the participants in step S103 in accordance with a shared rule determined in advance. Specifically, the CPU 11 performs one of the processes depicted in FIGS. 5, 8, 9, and 10, which are described below, or a combination of these processes. The CPU 11 causes, for example, the terminal apparatus 20 of the participant who is speaking, the terminal apparatus 20 specified in advance, the terminal apparatus 20 of a participant having a predetermined privilege, or the terminal apparatuses 20 of all the participants to present the states of the participants. The CPU 11 proceeds to step S104.

The CPU 11 determines in step S104 whether the remote conference has finished. If the CPU 11 determines that the remote conference has finished (YES in step S104), the CPU 11 finishes the presentation process. If the CPU 11 determines that the remote conference has not finished (NO in step S104), the CPU 11 proceeds to step S102.

As described above, the CPU 11 causes at least one of the multiple terminal apparatuses 20 to present the states of the multiple participants in the processes in steps S102 and S103 in accordance with a shared rule determined in advance, the states being deduced from the responses of the multiple participants in the remote conference in which the multiple terminal apparatuses 20 participate. Examples of the at least one terminal apparatus 20 include the terminal apparatus 20 that holds the remote conference. The states of the participants may be presented by all of the multiple terminal apparatuses 20.

FIG. 5 is a flowchart depicting a process performed by the information processing apparatus 10 to apply a shared rule.

The CPU 11 associates each state with a color, a symbol, or a sound effect in step S111. Examples of a symbol include a figure and an emoticon. A sound effect is usually used to represent a circumstance of a scene or a sentiment of a person at the scene. Examples of a sound effect also include a synthesized voice such as laughter or booing. The CPU 11 proceeds to step S112.

The CPU 11 provides the at least one terminal apparatus 20 with one or more colors, one or more symbols, or one or more sound effects in step S112. Examples of provision in this case include causing the display 16 to present colors, symbols, or sound effects and causing the display 26 of a terminal apparatus 20, which is a destination, to present colors, symbols, or sound effects after transmitting the colors, the symbols, or the sound effects via the communication interface 17. For example, the CPU 11 presents colors, symbols, or sound effects on a screen such as a remote-conference screen of the terminal apparatus 20. For example, the CPU 11 associates a positive state with red and a negative state with blue. The CPU 11 may associate each state with multiple colors, symbols, or sound effects. For example, the CPU 11 associates a positive state with red, associates the facial expression with an emoticon, and expresses a positive state of a participant by using an emoticon painted red. The CPU 11 finishes a process of applying a shared rule.

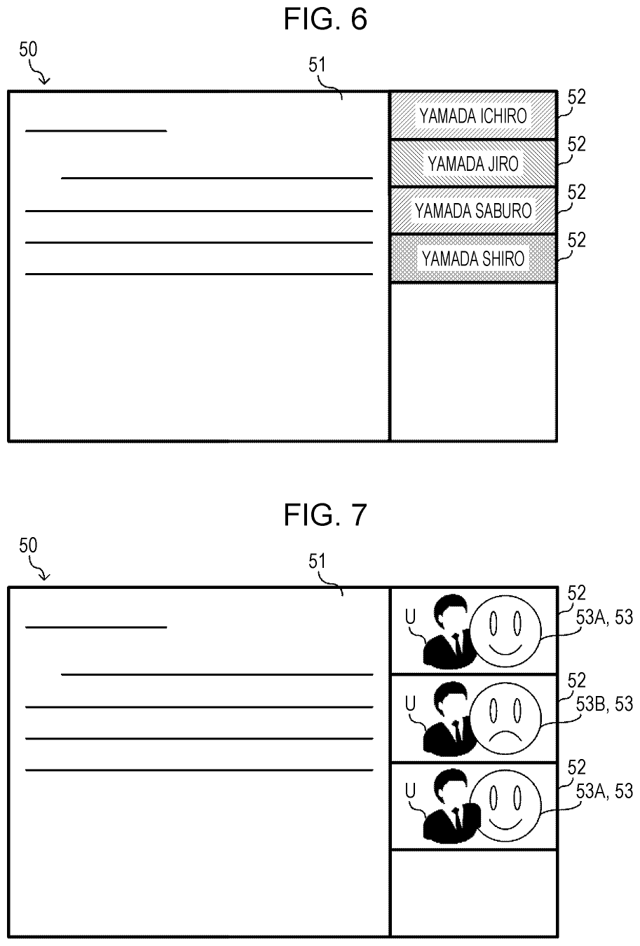

FIGS. 6 and 7 depict examples of a remote-conference screen 50 of a terminal apparatus 20 according to the first exemplary embodiment.

FIG. 6 is an example of the remote-conference screen 50 expressing the states of the participants associated with colors. The remote-conference screen 50 includes a document display region 51 and state display regions 52. The document display region 51 is used to present a document shared in a remote conference. Each of the state display regions 52 is used to present the state of a participant in accordance with a shared rule determined in advance.

Each of the state display regions 52 is used to present a color associated with the state of a participant. The state display region 52 may be used to present a color together with the name and the identification number such as the ID of a participant. The state display region 52 may be used to present a color as the background color of a captured image or video image of a participant. In the state display regions 52 in FIG. 6, for example, an area hatched by using parallel lines running downward to the right represents an area painted red, an area hatched by using parallel lines running upward to the right represents an area painted blue, and a cross-hatched area represents an area painted yellow.

FIG. 7 is an example of the remote-conference screen 50 expressing the states of the participants associated with symbols. Each of the state display regions 52 is used to present a symbol 53 associated with the state of a participant. The state display region 52 may be used to present a symbol 53A representing a smiling face when a participant expresses a supportive attitude or a symbol 53B representing a bored expression on the face when a participant expresses an unsupportive attitude. Each of the symbols 53 may be superimposed onto the foreground or background of a portrait U, which is a captured image or video image of a participant, in the state display region 52.

As described above, the CPU 11 associates each state with a color, a symbol, or a sound effect and provides at least one terminal apparatus 20 with the color, the symbol, or the sound effect, which is associated, in the processes in steps S111 and S112.

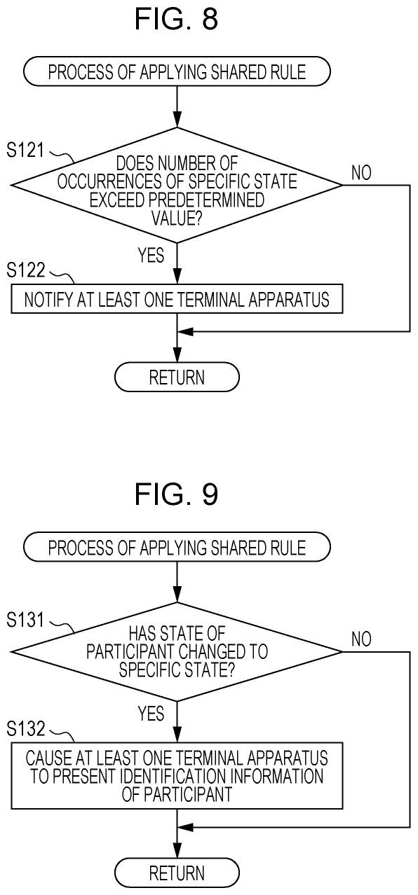

FIG. 8 is a flowchart depicting a process performed by the information processing apparatus 10 to apply a shared rule.

The CPU 11 determines in step S121 whether the number of occurrences of a specific state exceeds a predetermined value. If the CPU 11 determines that the number of occurrences of a specific state exceeds the predetermined value (YES in step S121), the CPU 11 proceeds to step S122. If the CPU 11 determines that the number of occurrences of a specific state does not exceed the predetermined value (NO in step S121), the CPU 11 finishes the process of applying a shared rule.

The CPU 11 notifies the at least one terminal apparatus 20 in step S122. Specifically, the CPU 11 notifies the at least one terminal apparatus 20 that the number of occurrences of a specific state exceeds a predetermined value. For example, the CPU 11 warns the at least one terminal apparatus 20 when the number of occurrences of a negative state exceeds a predetermined value. The CPU 11 finishes the process of applying a shared rule.

As described above, the CPU 11 notifies the at least one terminal apparatus 20 in the processes in steps S121 and S122 when the number of occurrences of a predetermined specific state exceeds a predetermined value.

FIG. 9 is a flowchart depicting a process performed by the information processing apparatus 10 to apply a shared rule.

The CPU 11 determines in step S131 whether the state of a participant has changed to a specific state. If the CPU 11 determines that the state of a participant has changed to a specific state (YES in step S131), the CPU 11 proceeds to step S132. If the CPU 11 determines that none of the states of the participants has changed to a specific state (NO in step S131), the CPU 11 finishes the process of applying a shared rule.

The CPU 11 causes the at least one terminal apparatus 20 to present the identification information of the participant in step S132. Examples of the identification information include the name, the identification number, the login name for the remote conference, and a captured image of the participant. In short, the CPU 11 provides the at least one terminal apparatus 20 with the identification information of the participant who has reached the specific state. The CPU 11 finishes the process of applying a shared rule.

As described above, the CPU 11 causes the at least one terminal apparatus 20 to present the identification information of a participant in the processes in steps S131 and S132 when the state of the participant has changed to a predetermined specific state.

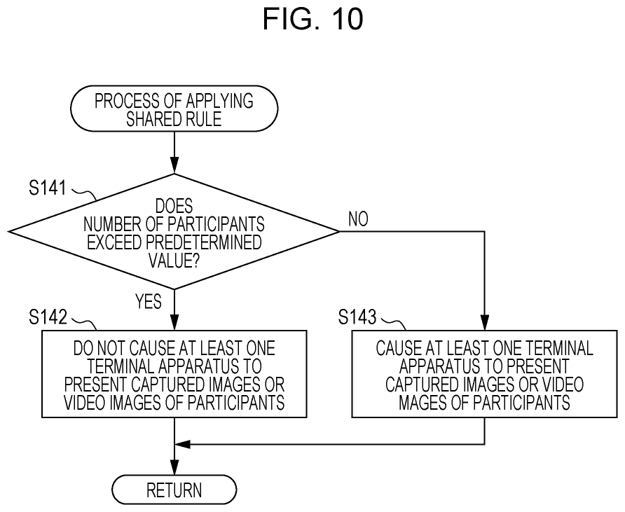

FIG. 10 is a flowchart depicting a process performed by the information processing apparatus 10 to apply a shared rule.

The CPU 11 determines in step S141 whether the number of the participants exceeds a predetermined value. If the CPU 11 determines that the number of the participants exceeds the predetermined value (YES in step S141), the CPU 11 proceeds to step S142. If the CPU 11 determines that the number of the participants does not exceed the predetermined value (NO in step S141), the CPU 11 proceeds to step S143.

The CPU 11 does not cause the at least one terminal apparatus 20 to present captured images or video images of the participants in step S142. The CPU 11 finishes the process of applying a shared rule.

The CPU 11 causes the at least one terminal apparatus 20 to present captured images or video images of the participants in step S143. The CPU 11 finishes the process of applying a shared rule.

As described above, the CPU 11 does not cause the at least one terminal apparatus 20 to present captured images or video images of the participants in the processes in steps S141 to S143 when the number of the participants exceeds a predetermined value. In other words, the CPU 11 causes the at least one terminal apparatus 20 to present captured images or video images of the participants when the number of the participants does not exceed a predetermined value.

### Second Exemplary Embodiment

Next, the second exemplary embodiment will be described. The method in the second exemplary embodiment includes a process of counting the number of occurrences of each state in addition to the method in the first exemplary embodiment. The hardware configuration in the second exemplary embodiment is the same as the hardware configuration in the first exemplary embodiment. Configurations and operations that are the same as or similar to the configurations and operations in the first exemplary embodiment are denoted by the same signs, and descriptions with regard to such configurations and operations will be omitted.

An operation of an information processing apparatus 10 according to the second exemplary embodiment will be described.

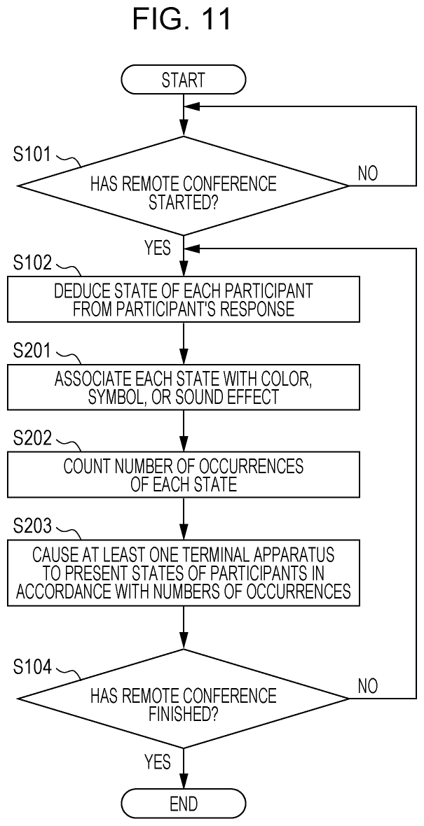

FIG. 11 is a flowchart depicting a presentation process performed by the information processing apparatus 10. Processes that differ from the processes performed by the information processing apparatus 10 according to the first exemplary embodiment will be described.

The CPU 11 proceeds to step S201 after performing the process in step S102.

The CPU 11 associates each state with a color, a symbol, or a sound effect in step S201. The process in step S201 is the same as or similar to the process in step S111 described above. The CPU 11 proceeds to step S202.

The CPU 11 counts the number of occurrences of each state in step S202. The CPU 11 proceeds to step S203.

The CPU 11 causes at least one terminal apparatus 20 to present the states of the participants in accordance with the numbers of occurrences in step S203. The CPU 11 causes the at least one terminal apparatus 20 to present, for example, at least one state with the counted number of occurrences that is largest or that exceeds a predetermined value. The predetermined value may be defined as a ratio of the number of occurrences of a state to the total number of states of the participants. The CPU 11 presents the ratio, for example, by using a numerical value or a color for each state. The CPU 11 proceeds to step S104.

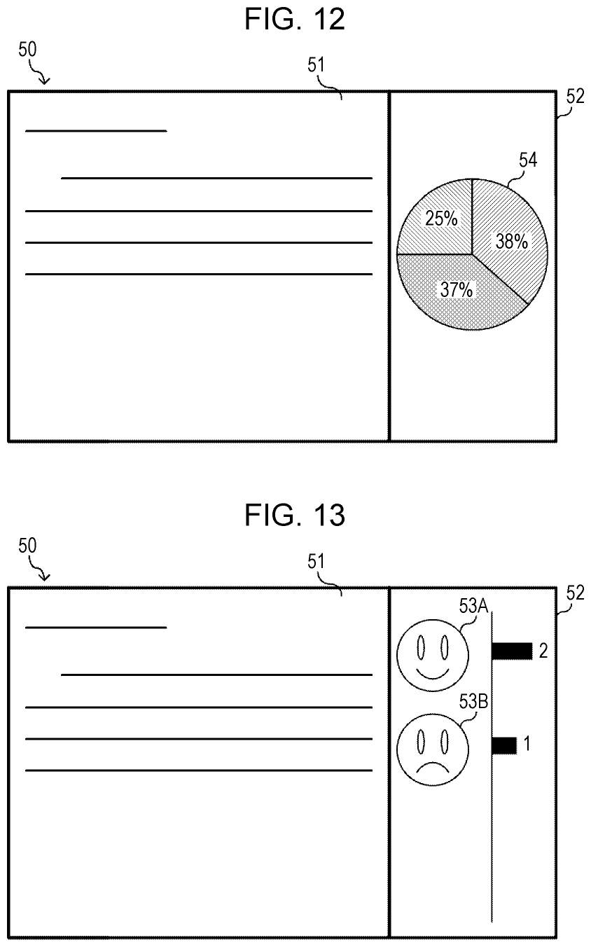

FIGS. 12 and 13 depict examples of a remote-conference screen 50 of a terminal apparatus 20 according to the second exemplary embodiment. A state display region 52 of the remote-conference screen 50 of the terminal apparatus 20 according to the second exemplary embodiment is used to present the states of the participants in a presentation mode in accordance with the numbers of occurrences.

FIG. 12 is an example of the remote-conference screen 50 expressing the states of the participants associated with colors. The state display region 52 is used to present a pie chart representing the ratios of the states of the participants. For example, each section of a pie chart is painted with the color associated with a state of participants and represents a percentage.

FIG. 13 is an example of the remote-conference screen 50 expressing the states of the participants associated with symbols. The state display region 52 is used to present a bar chart representing the ratios of the states of the participants. For example, symbols associated with the states of the participants are arranged on the vertical axis of the bar chart, and a bar representing the number of occurrences of each state is presented together with the number of occurrences on the horizontal axis.

As described above, the CPU 11 counts the number of occurrences of each state and causes the at least one terminal apparatus 20 to present the states in accordance with the numbers of occurrences in the processes in steps S201 to S203.

### MODIFICATIONS

The information processing apparatuses 10 according to the first and second exemplary embodiments have been described. However, the present disclosure is not limited to the exemplary embodiments described above. Various improvements and modifications are possible.

The information processing apparatus 10 may be built into a terminal apparatus 20. In other words, a remote conference may be managed by one of the terminal apparatuses 20. In addition, a remote conference may be held in a mesh form by using technology such as peer-to-peer (P2P) technology.

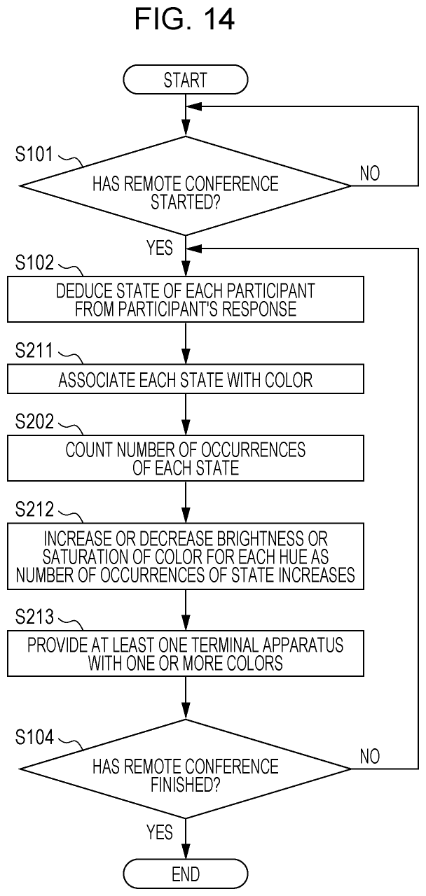

The information processing apparatus 10 according to the second exemplary embodiment may be configured to change the brightness or saturation of a color associated with a state. FIG. 14 is a flowchart depicting a presentation process of the information processing apparatus 10 according to a modification. Processes that differ from the processes performed by the information processing apparatus 10 according to the second exemplary embodiment will be described below.

The CPU 11 proceeds to step S211 after performing the process in step S102.

The CPU 11 associates each state with a color in step S211. The CPU 11 proceeds to step S202.

The CPU 11 proceeds to step S212 after performing the process in step S202.

The CPU 11 increases or decreases the brightness or saturation of the color for each hue in step S212 as the number of occurrences of a state increases. For example, the CPU 11 increases the color density as the number of occurrences of a state increases. The CPU 11 proceeds to step S213.

The CPU 11 provides the at least one terminal apparatus 20 with one or more colors in step S213. The CPU 11 proceeds to step S104.

As described above, the CPU 11 associates each state with a color and counts the number of occurrences of each state in the processes in steps S211 to S213. Then, as the number of occurrences of the state associated with a color increases, the CPU 11 increases or decreases the brightness or saturation of the color for each hue and provides the at least one terminal apparatus 20 with the color.

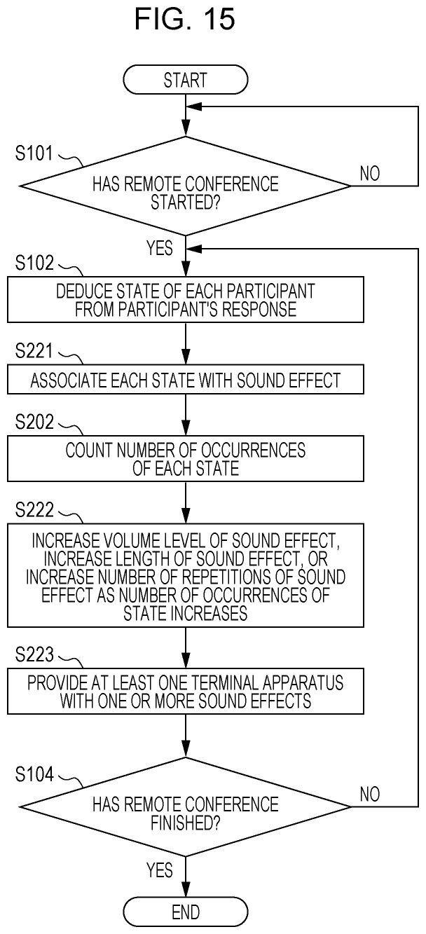

The information processing apparatus 10 according to the second exemplary embodiment may be configured to change a parameter such as the volume level of a sound effect in accordance with a state. FIG. 15 is a flowchart depicting a presentation process of the information processing apparatus 10 according to a modification. Processes that differ from the processes performed by the information processing apparatus 10 according to the second exemplary embodiment will be described below.

The CPU 11 proceeds to step S221 after performing the process in step S102.

The CPU 11 associates each state with a sound effect in step S221. The CPU 11 proceeds to step S202.

The CPU 11 proceeds to step S222 after performing the process in step S202.

As the number of occurrences of a state increases, the CPU 11 increases the volume level of a sound effect, increases the length of a sound effect, or increases the number of repetitions of a sound effect in step S222. The CPU 11 proceeds to step S223.

The CPU 11 provides the at least one terminal apparatus 20 with one or more sound effects in step S223. The CPU 11 proceeds to step S104.

As described above, the CPU 11 associates each state with a sound effect and counts the number of occurrences of each state in the processes in steps S221 to S223. Then, as the number of occurrences of the state associated with a sound effect increases, the CPU 11 increases the volume level of the sound effect, increases the length of the sound effect, or increases the number of repetitions of the sound effect and provides the at least one terminal apparatus 20 with the sound effect.

The CPU 11 saves the time, the one or more pages of the shared document, the specific state, and/or the identification information of the participant who has reached the specific state to the ROM 12 or the storage unit 14 in step S132 in FIG. 9. The content of the presentation can be reviewed based on such information.

The processes described above may also be achieved by using dedicated hardware circuitry. In such a case, a piece of hardware may perform the processes, or multiple pieces of hardware may perform the processes.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The programs for operating the information processing apparatus 10 may be provided by using a computer readable recording medium, such as a universal-serial-bus (USB) memory, a flexible disc, or a compact disc read-only memory (CD-ROM), or may be provided online via a network, such as the Internet. In such cases, the programs recorded in a computer readable recording medium are typically transferred to and stored in, for example, a memory or a storage unit. Further, these programs may be provided, for example, as stand-alone application software or may be built into the software of each unit in the information processing apparatus 10 as a function.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing program causing a computer to execute a process for information processing for a room in which metadata is transmitted and received by a plurality of terminal apparatuses, the process comprising:
causing at least one of the plurality of terminal apparatuses to present states of a plurality of participants in the room in accordance with a shared rule determined in advance, the states being deduced from responses of the plurality of participants.
   (((2)))

The information processing program according to (((1))),
wherein the shared rule requires each of the states to be associated with a color, a symbol, or a sound effect, and
the process comprises providing the at least one of the plurality of terminal apparatuses with the color, the symbol, or the sound effect that is associated with each of the states.
   (((3)))

The information processing program according to (((2))),
wherein the shared rule requires each of the states to be associated with a color, and
the process comprises presenting a background of an image or a video image by using the color, the image or the video image representing one of the plurality of participants.
   (((4)))

The information processing program according to (((2))),
wherein the shared rule requires each of the states to be associated with a symbol, and
the process comprises presenting an image or a video image with the symbol superimposed onto the image or the video image, the image or the video image representing one of the plurality of participants.
   (((5)))

The information processing program according to any one of (((1))) to (((4))),
wherein the shared rule requires the number of occurrences of each of the states to be counted, and
the process comprises causing the at least one of the plurality of terminal apparatuses to present the states of the plurality of participants in accordance with the number of occurrences of each of the states.
   (((6)))

The information processing program according to (((5))),
wherein the process comprises causing the at least one of the plurality of terminal apparatuses to present at least one of the states, the counted number of occurrences of the at least one of the states being largest or exceeding a predetermined value.
   (((7)))

The information processing program according to (((5))) or (((6))),
wherein the process comprises notifying the at least one of the plurality of terminal apparatuses when the number of occurrences of a predetermined specific one of the states exceeds a predetermined value.
   (((8)))

The information processing program according to any one of (((5))) to (((7))),
wherein the shared rule requires each of the states to be associated with a color and requires the number of occurrences of each of the states to be counted, and
the process comprises increasing or decreasing brightness or saturation of the color for each hue as the number of occurrences of the state associated with the color increases and providing the at least one of the plurality of terminal apparatuses with the color.
   (((9)))

The information processing program according to any one of (((5))) to (((8))),
wherein the shared rule requires each of the states to be associated with a sound effect and requires the number of occurrences of each of the states to be counted, and
the process comprises increasing a volume level of the sound effect, increasing a length of the sound effect, or increasing the number of repetitions of the sound effect as the number of occurrences of the state associated with the sound effect increases and providing the at least one of the plurality of terminal apparatuses with the sound effect.
   (((10)))

The information processing program according to any one of (((1))) to (((9))),
wherein the process comprises causing the at least one of the plurality of terminal apparatuses to present identification information of one of the plurality of participants when a state of the one of the plurality of participants has changed to a predetermined specific state.
   (((11)))

The information processing program according to any one of (((1))) to (((10))),
wherein the process comprises not causing the at least one of the plurality of terminal apparatuses to present images or video images representing the plurality of participants when the number of the plurality of participants exceeds a predetermined value.
   (((12)))

An information processing apparatus for a remote conference in which a plurality of terminal apparatuses participate, the information processing apparatus comprising:
a processor configured to:
   cause at least one of the plurality of terminal apparatuses to present states of a plurality of participants in the remote conference in accordance with a shared rule determined in advance, the states being deduced from responses of the plurality of participants.

What is claimed is:

1. A non-transitory computer readable medium storing a program causing a computer to execute a process for information processing for a room in which metadata is transmitted and received by a plurality of terminal apparatuses, the process comprising:
causing at least one of the plurality of terminal apparatuses to present states of a plurality of participants in the room in accordance with a shared rule determined in advance, the states being deduced from responses of the plurality of participants.

2. The non-transitory computer readable medium according to claim 1,
wherein the shared rule requires each of the states to be associated with a color, a symbol, or a sound effect, and
the process comprises providing the at least one of the plurality of terminal apparatuses with the color, the symbol, or the sound effect that is associated with each of the states.

3. The non-transitory computer readable medium according to claim 2,
wherein the shared rule requires each of the states to be associated with a color, and
the process comprises presenting a background of an image or a video image by using the color, the image or the video image representing one of the plurality of participants.

4. The non-transitory computer readable medium according to claim 2,
wherein the shared rule requires each of the states to be associated with a symbol, and
the process comprises presenting an image or a video image with the symbol superimposed onto the image or the video image, the image or the video image representing one of the plurality of participants.

5. The non-transitory computer readable medium according to claim 1,
wherein the shared rule requires the number of occurrences of each of the states to be counted, and
the process comprises causing the at least one of the plurality of terminal apparatuses to present the states of the plurality of participants in accordance with the number of occurrences of each of the states.

6. The non-transitory computer readable medium according to claim 5,
wherein the process comprises causing the at least one of the plurality of terminal apparatuses to present at least one of the states, the counted number of occurrences of the at least one of the states being largest or exceeding a predetermined value.

7. The non-transitory computer readable medium according to claim 5,
wherein the process comprises notifying the at least one of the plurality of terminal apparatuses when the number of occurrences of a predetermined specific one of the states exceeds a predetermined value.

8. The non-transitory computer readable medium according to claim 5,
wherein the shared rule requires each of the states to be associated with a color and requires the number of occurrences of each of the states to be counted, and
the process comprises increasing or decreasing brightness or saturation of the color for each hue as the number of occurrences of the state associated with the color increases and providing the at least one of the plurality of terminal apparatuses with the color.

9. The non-transitory computer readable medium according to claim 5,
wherein the shared rule requires each of the states to be associated with a sound effect and requires the number of occurrences of each of the states to be counted, and
the process comprises increasing a volume level of the sound effect, increasing a length of the sound effect, or increasing the number of repetitions of the sound effect as the number of occurrences of the state associated with the sound effect increases and providing the at least one of the plurality of terminal apparatuses with the sound effect.

10. The non-transitory computer readable medium according to claim 1,
wherein the process comprises causing the at least one of the plurality of terminal apparatuses to present identification information of one of the plurality of participants when a state of the one of the plurality of participants has changed to a predetermined specific state.

11. The non-transitory computer readable medium according to claim 1,
wherein the process comprises not causing the at least one of the plurality of terminal apparatuses to present images or video images representing the plurality of participants when the number of the plurality of participants exceeds a predetermined value.

12. An information processing system for a room in which metadata is transmitted and received by a plurality of terminal apparatuses, the system comprising:
a processor configured to:
cause at least one of the plurality of terminal apparatuses to present states of a plurality of participants in the room in accordance with a shared rule determined in advance, the states being deduced from responses of the plurality of participants.

13. An information processing method for a room in which metadata is transmitted and received by a plurality of terminal apparatuses, the method comprising:
causing at least one of the plurality of terminal apparatuses to present states of a plurality of participants in the room in accordance with a shared rule determined in advance, the states being deduced from responses of the plurality of participants.
